(19) United States
(12) Patent Application Publication
(10) Pub. No.: US 2014/0094547 A1
(43) Pub. Date: Apr. 3, 2014

(54) REINFORCED HDPE COMPOUNDS WITH IMPROVED MECHANICAL PROPERTIES AND METHODS OF MAKING SAME

(71) Applicant: ASAHI KASEI PLASTICS NORTH AMERICA, INC., Fowlerville, MI (US)

(72) Inventors: Vaibhav Vishnu APTE, Fowlerville, MI (US); Steven James KAUFFMAN, Fowlerville, MI (US); Michael James BALOW, Fowlerville, MI (US); Laura Therese SHEREDA, Fowlerville, MI (US)

(73) Assignee: ASAHI KASEI PLASTICS NORTH AMERICA, INC., Fowlerville, MI (US)

(21) Appl. No.: 14/039,885

(22) Filed: Sep. 27, 2013

Related U.S. Application Data
(60) Provisional application No. 61/707,708, filed on Sep. 28, 2012.

(51) Int. Cl. C08L 23/06

(52) U.S. Cl. CPC C08L 23/06
USPC 524/153; 524/451

(57) ABSTRACT

A thermoplastic polyolefin composition comprising, based on the total mass of the composition, 10-75% by mass of high density polyethylene (HDPE), 8-30% by mass of elastomer, and 5-45% by mass of filler, wherein the composition has a Melt Flow Rate of 1.0-20 g/10 min according to ISO 1133 at 190° C./2.16 kg. The thermoplastic polyolefin composition is produced in a method comprising batch mixing or continuous mixing the HDPE, elastomer, and filler to form a melt blend, and cooling the melt blend to give the product. In addition, the thermoplastic polyolefin composition can be injection molded to form an article, which is preferably an automotive body part. The thermoplastic polyolefin composition exhibits improved heat deflection temperatures, improved ductile failure mode in low temperature atmosphere, improved flexural modulus and lower specific cost compared to polypropylene based thermoplastic polyolefin compositions.

This nonprovisional application claims the benefit of U.S. Provisional Application No. 61/707,708 filed on Sep. 28, 2012. The entire contents of the above application is hereby incorporated by reference.

### FIELD OF THE INVENTION

The present invention relates generally to reinforced high density polyethylene (“HDPE”) compounds having a wide variety of uses, including uses in automotive body parts.

### BACKGROUND OF THE INVENTION

A wide range of Thermoplastic Polyolefins (“TPOs”) are currently used in automotive body parts, as well as many other applications.

TPOs are multiphase blends in which Polypropylene (“PP”) is the continuous phase, and typically an olefinic copolymer elastomer is the dispersed phase. PP based TPOs are widely used because of their energy absorbing qualities, processability and balance of stiffness and impact. The PP in the continuous phase is semi-crystalline, so about 20% by mass glass fiber is added to the melt mix to increase the heat deflection temperature from 55° C. to 130° C. However, the glass transition temperature (“T_{g}”) of PP is approximately −10° C., so a substantial amount of elastomer must be added to meet sub-ambient impact strength requirements.

As such, an object of the present invention is to provide a new class of TPO's which meets the sub-ambient impact strength requirements while substantially retaining the other properties of conventional PP based TPO's.

### SUMMARY OF THE INVENTION

The present invention provides for a TPO composition based on HDPE which meets the above-described object. The HDPE has a glass transition temperature of approximately −125° C. The addition of HDPE improves the sub-ambient impact strength properties of the TPO composition compared to PP based TPO's, and it was surprising that the other mechanical properties of conventional PP based TPO's could substantially be retained.

Described herein are thermoplastic polyolefin compositions and processes for preparing the composition, and articles of manufacture prepared from the composition.

The thermoplastic polyolefin composition comprises, based on the total mass of the composition, 10-75% by mass of high density polyethylene (HDPE), 8-30% by mass of elastomer, and 5-45% by mass of filler, wherein the composition has a Melt Flow Rate of 1.0-20 g/10 min according to ISO 1133 at 190° C./2.16 kg.

The thermoplastic polyolefin composition is produced in a method comprising batch mixing or continuous mixing of: 10-75% by mass of high density polyethylene (HDPE), 8-30% by mass of elastomer, and 5-45% by mass of filler based on the total mass of the composition to form a melt blend, cooling the melt blend to give a product composition having a Melt Flow Rate of 1.0-20 g/10 min according to ISO 1133 at 190° C./2.16 kg.

In addition, the thermoplastic polyolefin composition can be injection molded to form an article. The inventive articles having improved ductile failure mode in sub-ambient temperatures may be suitable for automotive body parts such as in bumper fascia, door trim, instrument panels, glove box, side pillars, air bag housing etc. The inventive article may also be suitable for non-automotive applications such as recreational vehicles, marine, heavy trucking, and in other industries requiring cold temperature ductility.

The resulting TPOs exhibit improved ductile failure mode in sub-ambient temperatures. These and other features and advantages will be apparent from the following brief description of the drawings, detailed description, and appended claims and drawings.

### BRIEF DESCRIPTION OF THE DRAWINGS

Embodiments of the invention will now be described, by way of example, with reference to the accompanying drawing, wherein:

FIG. 1 depicts an extruder of the type used for batch or continuous mixing of the compounds of the invention.

### DETAILED DESCRIPTION

Described herein are thermoplastic polyolefin compositions and processes for preparing the same. The present invention also relates to articles of manufacture prepared from the compositions. Reference will now be made in detail to embodiments of the present disclosure, examples of which are described herein and illustrated in the accompanying drawings. While the invention may be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

The thermoplastic polyolefin composition comprises, based on the total mass of the composition, 10-75% by mass of high density polyethylene (HDPE), 8-30% by mass of elastomer, and 5-45% by mass of filler, wherein the composition has a Melt Flow Rate of 1.0-20 g/10 min according to ISO 1133 at 190° C./2.16 kg.

The compositions are present in a morphological form, in which the ethylene/α-olefin random copolymer is present as a discontinuous phase or dispersed domains within a continuous phase or matrix of the HDPE. The dispersed ethylene/α-olefin domains range in length from 0.1 microns to greater than 30 microns, but preferably from 0.1 to 10 microns, and most preferably from about 0.5 to 7 microns. When polypropylene is present, the morphology the compound shows a core shell structure with HDPE being continuous and polypropylene existing primarily within the elastomer domains.

### HDPE

The thermoplastic polyolefin composition comprises 10-75% by mass of high density polyethylene (HDPE) based on the total mass of the composition. Preferably, the composition comprises 15-65% by mass of HDPE. More preferably, the composition comprises 15-50% by mass of HDPE. When the concentration of the HDPE is kept outside the range of 10-75% by mass, the thermoplastic polyolefin composition does not possess the preferred mechanical properties such as ductile failure mode in sub-ambient temperature impact, tensile strength, flexural modulus and Heat Deflection Temperature (HDT). The HDPE preferably has a density of 0.94 g/cm³ or more. More preferably, the HDPE has a density of 0.94-0.96 g/cm³. In addition, the HDPE preferably has a Melt Flow Rate of 5 to 50 g/10 min according to ISO 1133 at 190° C./2.16 kg. More preferably, the HDPE has a Melt Flow Rate of 7 to 45 g/10 min. Herein, the HDPE is usually formed with monomers of only ethylene. It is, however, possible to include a small amount of α-olefin as a comonomer with the proviso that a density of HDPE is within the range of 0.94-0.96 g/cm³. Examples of α-olefins are propylene, butene, hexene, and octene.

### Elastomer

The thermoplastic polyolefin composition comprises 8-30% by mass of the elastomer based on the total mass of the composition. Preferably, the composition comprises 10-30% by mass of elastomer. More preferably, the composition comprises 10-25% by mass of elastomer. When the concentration of the elastomer is kept outside the range of 8-30% by mass, the thermoplastic polyolefin composition does not have the preferred sub-ambient Multiaxial Impact Strength along with acceptable tensile strength, flexural modulus and heat deflection temperature. The elastomer preferably is styrene type elastomer, polyolefin type elastomer, polyamide type elastomer, cross-linked type elastomer. Elastomers useful in this invention range vary widely, but include C₂C₃, C₂C₄, C₂C₆, C₂Cₛ, (collectively ethylene/α-olefin copolymers) and are typically with a density range from 0.86 to 0.89 g/cm³ and more preferably between 0.86 to 0.88 g/cm³, with melt index at 2.16 kg and 190° C. from 1 to 30 grams/10 minutes. Alternatively, diblock or triblock Hydrogenated Styrene-Ethylene-Butene-Styrene (HSEBS) or Hydrogenated Styrene-Ethylene-Propylene-Styrene (HSEPS) elastomers can be used separately or in combination with ethylene copolymers. These elastomers are chosen for their properties including low glass transition temperatures, sub-ambient impact strength, and high impact strength. Most preferably, the elastomer is an ethylene 1-octene copolymer.

### Filler

The thermoplastic polyolefin composition comprises 5-45% by mass of filler based on the total mass of the composition. Preferably, the composition comprises 5-40% by mass of filler. More preferably, the composition comprises 10-35% by mass of filler. Most preferably, the composition comprises 10-22% by mass of filler. When the concentration of the filler falls outside the range of 5-45% by mass, the thermoplastic polyolefin composition will not have the desired physical properties.

Desirable fillers include but are not limited to mineral aggregates (natural or synthetic), fibers, carbon black, graphite, wollastonite, natural and synthetic clays including nanoclays and organoclays, sand, fibrous magnesium oxysulfate, glass beads and any other porous or nonporous fillers and supports known in the art. Preferably, the filler is a mineral aggregate. Most preferably, the mineral aggregate is talc.

In preferred embodiments, the filler has an average particle size of 4 microns or less in the composition. More preferably, the average particle size is less than 3 microns. Most preferably, the average particle size is 0.1 to 2.5 microns. When the average particle size of the filler is greater than 4 microns, there may be a reduction in impact resistance in the composition and the composition may not have the preferred sub-ambient impact strength. The average particle size may be found using Scanning Electron Microscopy or Small Angle Light Scattering. The average particle size can be analyzed as below:
cutting the article of the present composition with a cutting machine such as microtome;
observing the cutting surface with using Scanning Electron Microscopy or Small Angle Light Scattering;
measuring a particle size of arbitrary 50 fillers; and
calculating the average particle size.

### Properties of Thermoplastic Polyolefin Composition

The thermoplastic polyolefin composition has a Melt Flow Rate (MFR) of 1.0-20 g/10 min according to ISO 1133 at 190° C./2.16 kg. Preferably, the composition has a MFR of 1.0-15 g/10 min. Most preferably, the composition has a MFR of 5.0-12 g/10 min. When the MFR of the composition is kept outside the range of 1.0-20 g/10 min, the thermoplastic polyolefin composition does not have good moldability (including injection moldability).

Preferably, the thermoplastic polyolefin composition has excellent sub-ambient characteristics. For instance, it is preferred that test articles molded from the thermoplastic composition exhibits ductile fracture at −30° C. when measured in a Multiaxial Impact Test according to ASTM D3763 at 2.2 m/s (5 mph). It is more preferred that test articles will meet this ASTM D3763 test at −40° C. It is most preferred that test articles will meet this ASTM D3763 test at −47° C.

The thermoplastic polyolefin composition preferably has an excellent balance of mechanical properties. The Flexural Modulus of the composition is at least 700 MPa according to ISO 178 and the Tensile Strength is at least 15 MPa according to ISO 527. Preferably, the Flexural Modulus of the composition is 750 to 1300 MPa and the Tensile Strength is 15 to 20 MPa.

Table 1 gives the values for preferred parameters of the inventive composition. Each value is determined using the ASTM or ISO protocol familiar to those skilled in the art.

TABLE 1
Preferred Properties for the Invention

| | | | | MORE |
|---|---|---|---|---|
| | | TEST | PREFERRED | PREFERRED |
| TEST DESCRIPTION | UNITS | METHOD | VALUE/RANGE | VALUE/RANGE |
| Melt Flow Rate, 190° C./2.16 kg | g/10 min | ISO 1133 | 1.0-20.0 | 5.0-12.0 |
| Filler Content, 816° C./10 minutes | % | ISO 3451 | 5-45% | 10-30% |
| Tensile Strength, 50 mm/min | Mpa | ISO 527 | ≧15.0 | 15-20 |
| Flexural Modulus Chord, 2 mm/min | Mpa | ISO 178 | ≧700 | 750-1300 |
| Flexural Strength, 2 mm/min | Mpa | ISO 178 | ≧17.0 | 17.0-24.0 |
| HDT @ .45 MPa | ° C. | ISO 75 | ≧60 | 61-75 |
| HDT @ 1.8 MPa | ° C. | ISO 75 | ≧35 | 35-45 |
| Multiaxial Impact, 2.2 m/s, −40° C. Failure | D/B | ASTM | D | D |
| Mode | | D3763 | | |
| Multiaxial Impact, 2.2 m/s, −30° C. Failure | D/B | ASTM | D | D |
| Mode | | D3763 | | |

B—denotes brittle failure mode
D—denotes ductile failure mode
HDT—denotes Heat Deflection Temperature.

### Additives

The thermoplastic polyolefin composition may further comprise polypropylene (PP). Preferably, the PP is a polypropylene impact copolymer (ICP). The ICP comprises a polypropylene component (A) of homopolymer polypropylene (hPP) or random copolymer polypropylene (RCP), and a rubber component (B) of propylene copolymer. The morphology is such that the matrix phase is comprised primarily of (A) while the dispersed phase is comprised primarily of (B). Preferred ICPs useful in this invention include those having one or more of the following properties: 1) total propylene content of at least 75 mass % (preferably at least 80 mass %, preferably at least 85 mass %, preferably at least 90 mass %, preferably at least 95 mass %) based on the mass of the ICP; and/or 2) total comonomer content of 1 to 35 mass % (preferably 2 to 30 mass %, preferably 3 to 25 mass %, preferably 5 to 20 mass %) based on the mass of the ICP; and/or 3) rubber content of 5 to 40 mass % (preferably 6 to 35 mass %, preferably 7 to 30 mass %, preferably 8 to 30 mass %) based upon the mass of the ICP; and/or 4) propylene content of the rubber component of 25 to 80 mass % (preferably 30 to 75 mass %, preferably 35 to 70 mass %, preferably at least 40 mass %) based on the mass of the rubber component; and/or 5) ratio of the intrinsic viscosity (IV) of the rubber component to the IV of the polypropylene component of 0.5 to 15 (preferably 0.75 to 12, preferably 1 to 8); and/or 6) propylene meso diads in the polypropylene component of 90 mass % or more (preferably 92 mass % or more, preferably 94 mass % or more, preferably 96 mass % or more); and/or 7) Mw of 20 to 2,000 kg/mol (preferably 50 to 1,000 kg/mol, preferably 90 to 500 kg/mol); and/or 8) melt flow rate (MFR) of 1 to 300 dg/min (preferably 5 to 150 dg/min, preferably 10 to 100 dg/min, preferably 15 to 80 dg/min, preferably 20 to 60 dg/min); and/or 9) melting point (Tₘ, second heat, peak) of 100° C. or more (preferably 110° C. or more, preferably 120° C. or more, preferably 130° C. or more, preferably 140° C. or more, preferably 150° C. or more, preferably 155° C. or more, preferably 160° C. or more); and/or 10) heat of fusion (H_{f}, second heat) of 60 J/g or more (preferably 70 J/g or more, preferably 80 J/g or more, preferably 90 J/g or more, preferably 95 J/g or more, preferably 100 J/g or more); and/or 11) glass transition temperature (T_{g}) of the rubber component of −30° C. or less (preferably −40° C. or less, preferably −50° C. or less); and/or 12) glass transition temperature (T_{g}) of the polypropylene component of −10° C. or more (preferably −5° C. or more, preferably 0° C. or more); and/or 13) flexural modulus of 300 to 3000 MPa (preferably 500 to 2500 MPa, preferably 700 to 2000 MPa, preferably 900 to 1500 MPa); and/or 14) notched Izod impact strength at 23° C. of 2.5 J/m or more (preferably 5 J/m or more, preferably 7.5 J/m or more, preferably 10 J/m or more, preferably 15 J/m or more, preferably 20 J/m or more, preferably 25 J/m or more, preferably 50 J/m or more); and/or 15) Gardner impact strength at −30° C. of 2 to 100 J (preferably 3 to 80 J, preferably 4 to 60 J); and/or 16) heat deflection temperature (HDT) of 80° C. or more (preferably 85° C. or more, preferably 90° C. or more, preferably 95° C. or more).

Comonomers used in conjunction with propylene to make an ICP are chosen from ethylene and C₄ to C₈ 1-olefins, preferably from ethylene and 1-butene. In a preferred embodiment, the comonomer is ethylene and is present in the ICP at 1 to 50 mass % (preferably 2 to 40 mass %, preferably 3 to 30 mass %, preferably 5 to 20 mass %) based on the mass of the ICP. In another preferred embodiment, the rubber component of the ICP comprises 20 to 75 mass % (preferably 25 to 70 mass %, preferably 30 to 65 mass %, preferably less than 60 mass %) ethylene, and the balance propylene, based on the mass of the rubber component. More than one comonomer may also be employed, preferably selected from ethylene and C₄ to C₈ 1-olefins, such as ethylene and butene-1 or ethylene and hexene-1, such that the rubber component comprises a propylene terpolymer.

Preferably, the mass ratio of HDPE/PP is at least 1 in the thermoplastic polyolefin composition. More preferably, the ratio is 1.0 to 3.0. Most preferably, the ratio is 1.0 to 1.2. When the HDPE/PP ratio of the composition is lower than 1, the thermoplastic polyolefin composition may not exhibit the preferred sub-ambient impact strength.

Preferably, the ratio of filler/elastomer is 0.5 to 2 in the thermoplastic polyolefin composition. More preferably, the ratio is 0.6 to 1.8. When the filler/elastomer ratio of the composition is outside the range of 0.5 to 2, the thermoplastic polyolefin composition may not have the desired balance of flexural modulus and heat deflection temperature measurements.

The thermoplastic polyolefin composition may further comprise at least one selected from the group consisting of divalent transition metal salt of carboxylic acid, maleic anhydride grafted copolymers, antioxidants, HALS, and other stabilizers.

A number of divalent transition metal salts of carboxylic acid can be included to improve the mechanical properties of the thermoplastic polyolefin composition, including but not limited salts of calcium, magnesium, and zinc. Generally, functional metal salts may be ionic compounds comprising a central metal element and one or more carboxylic acid functional moieties. Generally, ionic compounds having one, two, or more carboxylic acid functional moieties were suitably employed for this purpose. Ionic compounds containing aromatic ring-containing carboxylic acids, such as those containing one, two, or three aromatic rings, including fused aromatic rings, were also found to impart the improved mechanical properties desirable of thermoplastics. For example, zinc dimethacrylate, zinc diacrylate, zinc isobutyrate, zinc propionate, zinc acetate, zinc isovalerate, pivalic acid zinc salt, zinc stearate, maleic acid zinc salt, adipic acid zinc salt, zinc phenylacetate, zinc cinnamate, zinc hydrocinnamate, zinc naphthoate (or zinc salt of naphthoic acid), zinc naphthalene acetate (or the zinc salt of 1-naphthalene acetic acid), isophthalic acid zinc salt, and phthalic acid zinc salt, and their equivalents substituting calcium or magnesium instead of zinc as the metal center, and mixtures thereof, may be used as metal salts to improve the mechanical properties of polyolefins. While a number of metal carboxylates, or salts thereof, have been found to work for this purpose, zinc cinnamate, zinc hydrocinnamate, zinc naphthalene acetate, and zinc naphthoate are preferred, for example, for certain polyolefins.

Preferably, the divalent transition metal salts of carboxylic acid present in the thermoplastic polyolefin composition is in a concentration of 0.05 to 5% by mass based on the total mass of the composition. More preferably, the concentration is 0.5 to 2% by mass. Most preferably, the concentration is 0.5 to 1.5% by mass. When the thermoplastic polyolefin composition includes one or more of these divalent transition metal salts of carboxylic acid in a concentration of 0.05 to 5% by mass, they exhibit improved Heat Deflection Temperature measurements over the native polyolefin without adversely affecting the impact resistance.

Preferably, zinc is present in the thermoplastic polyolefin composition in a concentration of 0.09 to 0.4% by mass based on the total mass of the composition. More preferably, the concentration is 0.1 to 0.36% by mass. When the thermoplastic polyolefin composition includes zinc in a concentration of outside the range of 0.09 to 0.4% by mass, there may be a reduction in the Heat Deflection Temperature.

The thermoplastic polyolefin composition may contain polyolefins that have been post-reactor functionalized with maleic anhydride (also called maleated polyolefins), including maleated ethylene polymers, maleated EP Rubbers, and maleated propylene polymers. Preferably, the amount of free acid groups present in the maleated polyolefin is less than about 1000 ppm (preferably less than about 500 ppm, preferably less than about 100 ppm).

Particularly useful antioxidants and stabilizers such as organic phosphites, hindered amines (including high and low molecular weight hindered amine light stabilizers, or “HALS”), and phenolic antioxidants may be present in the thermoplastic polyolefin compositions of the invention from 0.001 to 2 wt % (preferably from 0.01 to 0.8 wt %, preferably from 0.02 to 0.6 wt %). Non-limiting examples of organic phosphites that are suitable are tris(2,4-di-tert-butylphenyl)phosphite (IRGAFOS 168) and di(2,4-di-tert-butylphenyl)pentaerithritol diphosphite (ULTRANOX 626). Non-limiting examples of hindered amines include poly[2-N,N′-di(2,2,6,6-tetramethyl-4-piperidinyl)-hexanediamine-4-(1-amino-1,1,3,3-tetramethylbutane)sym-triazine] (CHIMASORB 944); bis(1,2,2,6,6-pentamethyl-4-piperidyl)sebacate (TINUVIN 770); Poly[(6-morpholino-s-triazine-2,4-diyl)[2,2,6,6-tetramethyl-4-piperidyl)imino]-hexamethylene[(2,2,6,6-tetramethyl-4-piperidyl)imino]] (CYTEC CYASORB UV-3346); and (CYTEC CYASORB UV-3853S). Non-limiting examples of phenolic antioxidants include pentaerythrityl tetrakis(3,5-di-tert-butyl-4-hydroxyphenyl) propionate (IRGANOX 1010); and 1,3,5-Tri(3,5-di-tert-butyl-4-hydroxybenzyl-isocyanurate (IRGANOX 3114). Preferred antioxidants include phenolic antioxidants, such as Irganox 1010, Irganox, 1076 both available from BASF.

In another embodiment, the polymer concentrate may comprise one or more phenolic antioxidants. Preferred examples of phenolic antioxidants include substituted phenols such as 2,6-di-t-butylphenol in which a hydrogen atom at 2 and/or 6 position is substituted by an alkyl residue. Typical examples of the phenolic antioxidant include 2,6-di-t-butyl-p-cresol, 2,4,6-tri-t-butylphenol, vitamin E, 2-t-butyl-6-(3′-t-butyl-5′-methyl-2′-hydroxybenzyl)-4-methylphenyl acrylate, 2,2′-methylene-bis(4-methyl-6-t-butylphenyl), 2,2′-methylene-bis(4-ethyl-6-t-butyl-phenol), 2,2′-methylene-bis(6-cyclohexyl-4-methylphenol), 1,6-hexanediol-bis([3-(3,5-di-t-butyl[4-hydroxyphenyl])]propionate, and pentaerythrityl-tetrakis-[3-(3,5-di-t-butyl-4-hydroxyphenyl)]propionate.

### Process

The inventive compositions can be produced in a batch or continuous melt-mixing operation. The extruder may have a variety of screw configurations. Either a single screw or a twin screw extruder configuration can be used to produce these compounds. Twin screw extruders can have either a co-rotating or counter-rotating screw. It is preferred to use a co-rotating twin screw extruders such as is commercially available from Coperion GmbH with Headquarters in Stuggart, Germany. The inventive compounds disclosed can be produced using a 28 mm screw diameter Coperion co-rotating twin screw extruder.

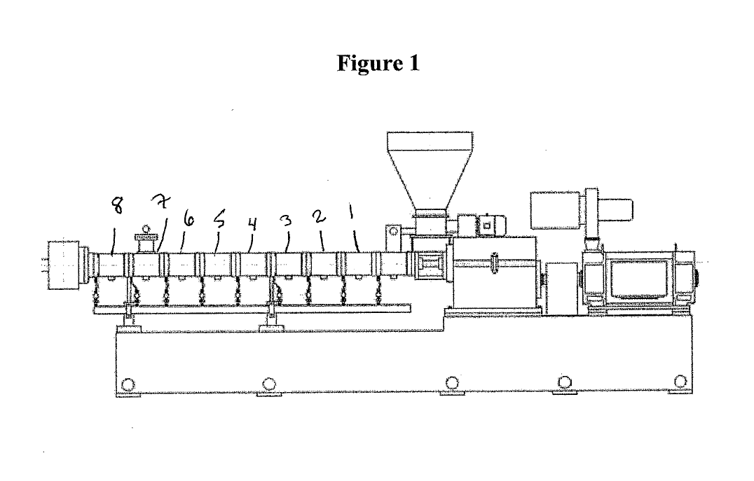

Extruders have multiple barrel heating zones and other processing parameters that interact with the screw elements to produce compounded materials. One such extruder is shown in FIG. 1. The acceptable and preferred ranges for the key variables are listed below in Table 2.

TABLE 2
Processing Conditions

| Condition | Acceptable | Preferred |
|---|---|---|
| Zone 1-4 Temperature(° F.) | 340-490 | 350-420 |
| Zone 5-8 Temperature (° F.) | 340-490 | 350-420 |
| Die Temperature (° F.) | 380-490 | 350-440 |
| Screw Rotation (rpm) | 300-1000 | 300-700 |
| Torque (%) | 30-95 | 50-85 |

Zones 1-8 are Numbered on FIG. 1.

Monomers and filler may be added into the extruder at varied positions along the extruder length, depending on the desired dwell time and mixing needed for each component. Stabilizers and other small volume quantities are preferably added with the monomers in the throat which is located upstream of Zone 1.

Table 3 below shows acceptable locations where the ingredients can be added:

TABLE 3
Ingredient Feeding Locations

| Ingredient | Feeding Location |
|---|---|
| Polyolefins | Throat or Downstream or Both |
| Elastomers | Throat |
| Performance additives | Throat |
| Antioxidants | Throat |
| Heat Stabilizers | Throat |
| UV Stabilizers | Throat |
| Filler | Throat or Downstream or Both |
| Colorants | Throat |

Typically the extruder output, which may be called “melt blend”, is strands that are pelletized. The shape of the pellet is determined with the cutting system of the extruder. In the present invention, any kind of shape, such as cylindrical and spherical, is acceptable. Size of the pellet is preferably 5 mm or less. More preferably, the size is 4 mm or less. In the case of cylindrical pellet, both of diameter and length is preferably 5 mm or less. More preferably, 50% by mass of the pellets in a batch have a size of 3 mm or less.

Pellets may subsequently be injection-molded, extruded, or thermoformed to produce finished articles and molded samples for physical property testing.

### Articles

The thermoplastic polyolefin composition of the present invention, which contains HDPE, exhibits improved properties such as improved heat deflection temperatures and improved ductile failure mode at sub-ambient temperatures. Therefore, the thermoplastic polyolefin composition of the present invention can be applied to various applications including automotive applications, recreational vehicles, marine, heavy trucking, and in other industries requiring cold temperature ductility. Especially, the thermoplastic polyolefin composition of the present invention can be used in automotive body parts. Examples of such automotive body parts include, but are not limited to bumper fascia, door trim, instrument panels, glove box, side pillars, air bag housing etc.

### EXAMPLES

The following examples illustrate the present invention. It is understood that these examples are given for the purpose of illustration and do not limit the invention. In the examples, all parts and percentages are by mass based on the total mass of the composition unless otherwise specified. In case of Multiaxial Impact test also sometimes referred to as Instrumented Dart Impact, the failure mode of plaques, is noted where D denotes ductile failure mode and B denotes brittle failure mode. The acronym HDT denotes Heat Deflection Temperature.

Table 4 provides a list of components used in the following examples discussed hereinbelow.

TABLE 4

| Material Trade Name | Material Description |
|---|---|
| Braskem, TI4350P | Polypropylene Impact Copolymer |
| Ferro, Magnesium Stearate 90C | Magnesium Stearate |
| BASF, Irganox 1010 | Sterically hindered phenolic |
| | antioxidant |
| BASF, Irgafos 168 | Trisaryl Phosphite Processing |
| | Stabilizer |
| Standridge Color, SSC 22598 | 50% Carbon Black in |
| | Polyethylene (“PE”) Carrier |
| Ineos HDPE T60-800 | HDPE, Melt Flow Rate 8.0 g/10 min, |
| | Density = 0.958 g/cm³ |
| Mitsui Chemicals, Tafmer | Polyolefin elastomer, Ethylene- |
| A-4050S | Butene Copolymer |
| Dow, Engage 8200 | Polyolefin Elastomer, Ethylene- |
| | Octene Copolymer |
| Cray Valley, CVX50005 | Zinc Cinnamate |
| Cytec, Cyasorb UV-3346 | Hindered Amine Light Stabilizer |
| | (“HALS”) |
| Cytec, Cyasorb UV-3853S | Hindered Amine Light Stabilizer |
| | (“HALS”) |
| ImiFabi, Talc HTP2c | Talc 2 micron, compacted |
| ImiFabi, Talc, Lo Micron #5 | Talc 0.5 micron, compacted |
| Cimbar, Cimtuff 9103 | 4 micron particle size, Compacted |
| | talc |

### Inventive Example 1 and Comparative Example 1

The compositions of Inventive Example 1 and Comparative Example 1 were prepared by melt mixing using a twin-screw extruder as shown in FIG. 1. The amounts of the specific components are provided in Table 5A and the properties of the compositions are provided in Table 5B.

TABLE 5A

| | MATERIAL BRAND/ | | |
|---|---|---|---|
| MATERIAL DESCRIPTION | GRADE NAME | IE1 | CE1 |
| Polypropylene Impact Copolymer | Braskem TI4350P | | 61.2 |
| HDPE, MFR = 8.0, Specific Gravity = 0.958 | Ineos T60-800 | 61.20 | |
| Polyolefin Elastomer, ethylene-octene copolymer | Dow Engage 8200 | 18.00 | 18.00 |
| Sterically hindered phenolic antioxidant | BASF Irganox 1010 | 0.15 | 0.15 |
| Trisaryl phosphite processing stabilizer | BASF Irgafos 168 | 0.05 | 0.05 |
| HALS | Cytec Cyasorb UV-3346 | 0.15 | 0.15 |
| HALS | Cytec Cyasorb UV-3853S | 0.45 | 0.45 |
| Talc 4 micron, compacted | Cimbar Cimtuff 9103 | 20.00 | 20.00 |

TABLE 5B
Properties Of The Compounds From Table 5A

| | | TEST | | |
|---|---|---|---|---|
| TEST DESCRIPTION | UNITS | METHOD | IE1 | CE1 |
| Melt Flow Rate, 190° C./ | g/10 min | ISO 1133 | 6.1 | 10.2 |
| 2.16 kg | | | | |
| Filler Content, 816° C./ | % | ISO 3451 | 19.9 | 19.5 |
| 10 minutes | | | | |
| Tensile Strength, 50 mm/min | Mpa | ISO 527 | 17.5 | 17.0 |
| Flexural Modulus Chord, | Mpa | ISO 178 | 1040 | 1390 |
| 2 mm/min | | | | |
| Flexural Strength, 2 mm/min | Mpa | ISO 178 | 19.0 | 23.0 |
| Notched Charpy Impact, | KJ/m² | ISO 179 | 13.8 | 19.0 |
| 23° C. | | | | |
| HDT @ .45 MPa | ° C. | ISO 75 | 62 | 93 |
| HDT @ 1.8 MPa | ° C. | ISO 75 | 37 | 49 |
| Multiaxial Impact, 2.2 m/s, | D/B | ASTM | NT | NT |
| −40° C. Failure Mode | | D3763 | | |
| Multiaxial Impact, 2.2 m/s, | D/B | ASTM | B | B |
| −30° C. Failure Mode | | D3763 | | |

B—denotes brittle failure mode
D—denotes ductile failure mode
NT—denotes not tested
IE—denotes inventive example
CE—denotes comparative example

IE1 which comprises a high amount of HDPE shows excellent mechanical properties, heat deflection temperature and dimensional stability of the molded materials.

CE1 does not contain 10-75% by mass HDPE. Table 5B shows that CE1 does not have the preferred balance of properties, and CE1 also undergoes brittle failure at −30° C.

### Inventive Examples 2 and 3 and Comparative Example 2

The compositions of Inventive Examples 2 and 3 and Comparative Example 2 were prepared in a similar manner to Inventive Example 1. The amounts of the specific components are provided in Table 6A and the properties of the compositions are provided in Table 6B.

TABLE 6A

| | MATERIAL BRAND/ | | | |
|---|---|---|---|---|
| MATERIAL DESCRIPTION | GRADE NAME | IE2 | IE3 | CE2 |
| HDPE, MFR = 8.0, Specific Gravity = 0.958 | Ineos T60-800 | 68.00 | 68.00 | 75.50 |
| Polyolefin Elastomer, ethylene-butene copolymer | Tafmer A-4050S | | 15.00 | 7.50 |
| Polyolefin Elastomer, ethylene-octene copolymer | Dow Engage 8200 | 15.00 | | |
| Magnesium Stearate | Ferro 90C | 0.20 | 0.20 | 0.20 |
| 50% Carbon Black in PE Carrier | Standridge SSC22598 | 1.00 | 1.00 | 1.00 |
| Sterically hindered phenolic antioxidant | BASF Irganox 1010 | 0.15 | 0.15 | 0.15 |
| Trisaryl phosphite processing stabilizer | BASF Irgafos 168 | 0.05 | 0.05 | 0.05 |
| HALS | Cytec Cyasorb UV-3346 | 0.15 | 0.15 | 0.15 |
| HALS | Cytec Cyasorb UV-3853S | 0.45 | 0.45 | 0.45 |
| Talc 2 micron, compacted | ImiFabi Talc HTP2c | 15.00 | 15.00 | 15.00 |

TABLE 6B

| | | TEST | | | |
|---|---|---|---|---|---|
| TEST DESCRIPTION | UNITS | METHOD | IE2 | IE3 | CE2 |
| Melt Flow Rate, 190° C./2.16 kg | g/10 min | ISO 1133 | 7.2 | 7.0 | 7.1 |
| Filler Content, 816° C./10 minutes | % | ISO 3451 | 15.0 | 14.5 | 15.0 |
| Tensile Strength, 50 mm/min | Mpa | ISO 527 | 18.6 | 17.7 | 20.7 |
| Flexural Modulus Chord, 2 mm/min | Mpa | ISO 178 | 822 | 756 | 972 |
| Flexural Strength, 2 mm/min | Mpa | ISO 178 | 19.9 | 18.2 | 21.9 |
| Notched Izod Impact, 23° C. | KJ/m² | ISO 180 | 11.5 | 12.1 | 5.9 |
| Notched Izod Impact, −30° C. | KJ/m² | ISO 180 | 4.1 | 5.5 | 3.5 |
| HDT @ .45 MPa | ° C. | ISO 75 | 65 | 67 | 69 |
| HDT @ 1.8 MPa | ° C. | ISO 75 | 41 | 40 | 42 |
| Multiaxial Impact, 2.2 m/s, −40° C. Failure Mode | D/B | ASTM D3763 | NT | NT | NT |
| Multiaxial Impact, 2.2 m/s, −30° C. Failure Mode | D/B | ASTM D3763 | D | D | B |

B—denotes brittle failure mode
D—denotes ductile failure mode
NT—denotes not tested
IE—denotes inventive example
CE—denotes comparative example

IE2 and IE3, which contain HDPE within the range of 10-75% by mass and contain two different types of polyolefin elastomers within the range of 8-30% by mass, show excellent mechanical properties, heat deflection temperature and dimensional stability of the molded materials. Also, these samples showed ductile failure at −30° C.

CE2 does not contain the polyolefin elastomer within the range of 8-30% by mass. As such, even with the use of talc having an average particle size of 2 microns, CE2 undergoes brittle failure at −30° C. Therefore, the polyolefin elastomer content must be no less than 8% by mass.

### Inventive Examples 4-6 and Comparative Examples 3-4

The compositions of Inventive Examples 4-6 and Comparative Examples 3-4 were prepared in a similar manner to Inventive Example 1. The amounts of the specific components are provided in Table 7A and the properties of the compositions are provided in Table 7B.

TABLE 7A

| | MATERIAL BRAND/ | | | | | |
|---|---|---|---|---|---|---|
| MATERIAL DESCRIPTION | GRADE NAME | IE4 | IE5 | IE6 | CE3 | CE4 |
| Polypropylene Impact Copolymer | Braskem TI4350P | 30.10 | 30.60 | | 61.20 | 60.20 |
| HDPE, MFR = 8.0, Specific | Ineos T60-800 | 30.10 | 30.60 | 61.20 | | |
| Gravity = 0.958 | | | | | | |
| Polyolefin Elastomer, ethylene- | Dow Engage 8200 | 18.00 | 18.00 | 18.00 | 18.00 | 18.00 |
| octene copolymer | | | | | | |
| Zinc Cinnamate | Cray Valley CVX50005 | 1.00 | | | | 1.00 |
| Sterically hindered phenolic | BASF Irganox 1010 | 0.15 | 0.15 | 0.15 | 0.15 | 0.15 |
| antioxidant | | | | | | |
| Trisaryl phosphite processing | BASF Irgafos 168 | 0.05 | 0.05 | 0.05 | 0.05 | 0.05 |
| stabilizer | | | | | | |
| HALS | Cytec Cyasorb UV-3346 | 0.15 | 0.15 | 0.15 | 0.15 | 0.15 |
| HALS | Cytec Cyasorb UV-3853S | 0.45 | 0.45 | 0.45 | 0.45 | 0.45 |
| Talc 0.5 micron, compacted | ImiFabi Talc Lo Micron #5 | 20.00 | 20.00 | 20.00 | 20.00 | 20.00 |

TABLE 7B

| | | TEST | | | | | |
|---|---|---|---|---|---|---|---|
| TEST DESCRIPTION | UNITS | METHOD | IE4 | IE5 | IE6 | CE3 | CE4 |
| Melt Flow Rate, 190° C./2.16 kg | g/10 min | ISO 1133 | 7.4 | 7.6 | 6.0 | 10 | 9.7 |
| Filler Content, 816° C./10 minutes | % | ISO 3451 | 21.2 | 20.8 | 21.7 | 19.1 | 21.9 |
| Tensile Strength, 50 mm/min | Mpa | ISO 527 | 16.2 | 16.6 | 18.7 | 18.5 | 17.2 |
| Flexural Modulus Chord, 2 mm/min | Mpa | ISO 178 | 1160 | 1240 | 1230 | 1660 | 1570 |
| Flexural Strength, 2 mm/min | Mpa | ISO 178 | 19.7 | 20.8 | 21.4 | 25.6 | 24.1 |
| Notched Charpy Impact, 23° C. | KJ/m² | ISO 179 | 71.9 | 67.2 | 36.3 | 40.0 | 44.5 |
| HDT @ .45 MPa | ° C. | ISO 75 | 73 | 69 | 65 | 98 | 98 |
| HDT @ 1.8 MPa | ° C. | ISO 75 | 44 | 44 | 40 | 53 | 52 |
| Multiaxial Impact, 2.2 m/s, −40° C. | D/B | ASTM D3763 | D | D | D | B | B |
| Failure Mode | | | | | | | |
| Multiaxial Impact, 2.2 m/s, −30° C. | D/B | ASTM D3763 | D | D | D | B | B |
| Failure Mode | | | | | | | |

B—denotes brittle failure mode
D—denotes ductile failure mode
NT—denotes not tested
IE—denotes inventive example
CE—denotes comparative example

IE4 and IE5 contain PP as well as HDPE in a ratio of HDPE/PP of 1. IE4 also includes the additive zinc cinnamate.

IE6 does not include PP, but retains the HDPE within the range of 10-75 mass %.

CE3 and CE4 do not contain 10-75% by mass HDPE and they incorporate a high amount of PP instead.

IE4 and CE4 include the additive zinc cinnamate.

All of samples IE4-IE6 and CE3-CE4 include talc having the preferred small average particle size, i.e., 0.5 microns. Nevertheless, each of CE3 and CE4 failed to show good sub-ambient impact strength.

With the combination of the talc having a small average particle size and maintaining the HDPE/PP ratio at ≧1, the samples IE4-IE6 showed a ductile failure at the very low temperature of −40° C. and these samples showed a good combination of mechanical properties.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

The transitional phrase “consisting essentially of”, when used herein, limits the scope to the specified materials or steps and those that do not materially affect the basic and novel characteristics of the invention.

Any reference herein to a “mass %” value, is based on the total mass of the composition, unless otherwise specified.

What is claimed is:

1. A thermoplastic polyolefin composition comprising, based on the total mass of the composition,
10-75% by mass of high density polyethylene (HDPE), 8-30% by mass of elastomer, and 5-45% by mass of filler,
wherein the composition has a Melt Flow Rate of 1.0-20 g/10 min according to ISO 1133 at 190° C./2.16 kg.

2. The thermoplastic polyolefin composition according to claim 1, wherein the elastomer is selected from polyolefin type elastomer.

3. The thermoplastic polyolefin composition according to claim 1, wherein the elastomer is a copolymer of ethylene and C₃-8 α-olefin.

4. The thermoplastic polyolefin composition according to claim 1, wherein the filler has an average particle size of 3 microns or less in the composition.

5. The thermoplastic polyolefin composition according to claim 1, wherein the filler is talc.

6. The thermoplastic polyolefin composition according to claim 1, which further comprises polypropylene (PP), and the amount ratio of HDPE/PP is at least 1.

7. The thermoplastic polyolefin composition according to claim 1, which further comprises at least one selected from the group consisting of divalent transition metal salt of carboxylic acid, maleic anhydride grafted copolymer, antioxidant and stabilizer.

8. The thermoplastic polyolefin composition according to claim 7, wherein the metal of the divalent transition metal salt of carboxylic acid is zinc.

9. The thermoplastic polyolefin composition according to claim 7, wherein the divalent transition metal salt of carboxylic acid is zinc cinnamate.

10. The thermoplastic polyolefin composition according to claim 1, wherein the composition satisfies the following:
test articles molded from the thermoplastic composition exhibits ductile fracture at −30° C. when measured in a Multiaxial Impact Test at 2.2 m/s test speed according to ASTM D3763.

11. The thermoplastic polyolefin composition according to claim 10, wherein the composition further satisfy the following:
the Flexural Modulus of at least 700 MPa according to ISO 178;
the Heat Deflection Temperature is at least 35° C. at 1.8 MPa according to ISO 75; and
the Tensile Strength is at least 15 MPa according to ISO 527.

12. The thermoplastic polyolefin composition according to claim 1, wherein the composition satisfies the following:
test articles molded from the thermoplastic composition exhibit ductile fracture at −40° C. when measured in a Multiaxial Impact Test at 2.2 m/s test speed according to ASTM D3763.

13. A method of making a thermoplastic polyolefin composition comprising batch mixing or continuous mixing of:
10-75% by mass of high density polyethylene (HDPE), 8-30% by mass of elastomer, and 5-45% by mass of filler based on the total mass of the composition to form a melt blend,
cooling the melt blend to give a product composition,
wherein the product composition has a Melt Flow Rate of 1.0-20 g/10 min according to ISO 1133 at 190° C./2.16 kg.

14. An article obtained by injection molding the thermoplastic polyolefin composition according to claim 1.

15. The article according to claim 14, wherein the article is an automotive body part.

16. An article obtained by injection molding the thermoplastic polyolefin composition according to claim 2.

17. The article according to claim 16, wherein the article is an automotive body part.

18. An article obtained by injection molding the thermoplastic polyolefin composition according to claim 3.

19. The article according to claim 18, wherein the article is an automotive body part.
